(19) United States
(12) Patent Application Publication
(10) Pub. No.: US 2018/0371726 A1
(43) Pub. Date: Dec. 27, 2018

(54) RENEWABLE ENERGY-BASED ATMOSPHERIC WATER GENERATOR

(71) Applicants: Elizabeth Nowak, East Aurora, NY (US); Guy Katz, Ashkelon (IL)

(72) Inventors: Elizabeth Nowak, East Aurora, NY (US); Guy Katz, Ashkelon (IL)

(21) Appl. No.: 15/012,282

(22) Filed: Feb. 1, 2016

(51) Int. Cl. E03B 3/28; F24S 23/77; B01D 5/00

(52) U.S. Cl. CPC E03B 3/28; B01D 5/0003; F24S 23/77

(57) ABSTRACT

A method and apparatus for generating water from an atmospheric water source involving (a) collecting a fixed volume of ambient air in a chamber; (b) raising the pressure of the fixed volume of ambient air in the chamber by heating the fixed volume of ambient air with a solar heater thereby increasing the dew point of the fixed volume of ambient air in the chamber; (c) cooling a surface of the chamber with air outside the chamber; (d) condensing the water in the fixed volume of ambient air in the chamber on the cooling surface when the dew point is greater than the temperature of the cooling surface that is in contact with outside air; (d) collecting the resulting dew in a collection basin; and (f) refreshing the air supply within the chamber.

### RELATED APPLICATIONS

None.

### FIELD

The present invention relates to the field of water collection, and in particular, to the field of atmospheric water generation. More specifically, the present invention relates to energy efficient water generation devices.

### BACKGROUND

Access to fresh water is central to the health and economic prosperity of a community. The UN estimates that 880 million people around the world do not have access to a regular supply of clean fresh water. As a result, 5,000 children die every day from waterborne diseases, and countless families go without sufficient water for drinking, food-preparation and sanitation. Furthermore, people in water-poor areas spend valuable time collecting and transporting water to their homes—time that could be otherwise spent on work and education.

The issue of inequality in the distribution of fresh water resources is compounded by the problem of over-use. The fresh water resources to which we have access—lakes, rivers, and ground aquifers—are being depleted at an alarming rate. This is a threat to ecosystems, as well as human health, survival, and security everywhere on the planet. Desalination systems attempt to address this issue, but the technology is energy-inefficient and inaccessible to most of the population. There are around 3,100 cubic miles of water in the atmosphere at any given time, yet there have been only limited attempts to utilize this resource. There have been even fewer efforts to gather atmospheric water in such a way that is energy and cost efficient. As described below, the prior art fails to disclose a simple, energy and cost efficient method and apparatus for gathering atmospheric water.

U.S. Pat. No. 4,285,702 issued Aug. 25, 1981 to Helmut et al describes a system whereby air is absorbed, heated and condensed to yield water. The invention includes a sun collector, a series of fans, an absorber bed, and a heat-retaining medium. The apparatus is used in cycles of day and night. However, the present invention is distinguishable from '702 patent in that the present invention functions independent of cycles of day and night.

U.S. Pat. No. 4,433,552 issued Feb. 28, 1984 to Smith describes a method and apparatus for recovering atmospheric moisture based on a wind-driven electrical generator that powers a refrigeration system. The present invention is distinguishable from the '352 patent as it does not require any electricity or refrigeration to function.

U.S. Pat. No. 5,669,221 issued Sep. 23, 1997 to LeBleu et al describes a portable atmospheric water generator based on a resistance-heating strip and fan that warms the air before condensing the water. The present invention is distinguishable from the '221 patent as it uses a solar heating apparatus rather than a resistance-heating strip and fan combination to heat the air before condensing the water.

U.S. Pat. No. 8,196,422 issued Jun. 12, 2012 to Ritchey describes an energy-efficient solar-powered atmospheric water generator that uses solar heat to power a refrigeration system. The solar heat itself is only a means of power, not integral to altering the dew-point gradient. It still depends on a refrigerant (pure ammonia) to lower the temperature below ambient air. This follows the design of conventional atmospheric water generators; it just substitutes solar power for more traditional sources of energy. The present invention is distinguishable from the '422 patent in that it does not require a refrigerant solution to cool the air prior to condensing the water but rather it raises the temperature to alter the dew point gradient altogether.

U.S. Pat. No. 6,116,034 to Alexeev uses heat as a means of moving ambient air through the apparatus, in order to facilitate a natural condensation process. The apparatus works in an open system, which means it does not create a lasting pressure gradient in the heated air. The present invention uses a fixed volume closed system to heat air, which will increase pressure and therefore relative humidity, which will result in a dew point lower than ambient atmosphere.

The present invention is distinguishable from some of the issued patents listed above that address the concept of extracting water from atmospheric air because they rely on on-grid power sources to function. Furthermore, all of the issued patents listed above are dependent on refrigerant coolants and at least two steps of energy conversion, which fundamentally reduces the efficiency of the systems. As such, the present invention seeks to provide a novel apparatus that uses wind and solar energy in a heat exchange process that generates potable water from an atmospheric water source. The apparatus of the present invention is simple, low-cost, and depends only on renewable resources to generate water.

### BRIEF SUMMARY OF THE INVENTION

It is the object of the present invention to address several challenges in previous attempts to generate water from atmospheric air. The present invention is entirely off of the energy grid and requires only one step of energy conversion. Furthermore, it does not depend on a refrigerant solution for cooling purposes. The apparatus can be used on a large scale, or it can be scaled-down to a personal, portable level.

One embodiment of the present invention is a method for generating water from an atmospheric water source comprising: (a) collecting a fixed volume of ambient air in a chamber; (b) raising the pressure of the fixed volume of ambient air in the chamber by heating the fixed volume of ambient air with a solar heater thereby increasing the dew point of the fixed volume of ambient air in the chamber; (c) cooling a surface of the chamber with air outside the chamber; (d) condensing the water in the fixed volume of ambient air in the chamber on the cooling surface when the dew point is greater than the temperature of the cooling surface that is in contact with outside air; (d) collecting the resulting dew in a collection basin; and (f) refreshing the air supply within the chamber.

A second embodiment of the present invention is an apparatus for generating water from an atmospheric water source comprising: (a) a fixed volume air chamber; (b) a solar oven; (d) a source of relatively cold air; (d) a trap door in the bottom of the air chamber; and (d) a water collection basin. The solar oven collects energy to heat ambient air collected in the fixed volume air chamber. Then the bottom surface of the fixed volume air chamber is cooled by the source of relatively cold air thereby condensing water from the fixed volume of heated ambient air in the chamber on the cooling surface when the dew point of the heated air is greater than the temperature of the cooling surface that is in contact with relatively cold air. When the water reached a predetermined level or weight, the trap door in the bottom of the air chamber releases to dump the water in the water collection basin.

### BRIEF DESCRIPTION OF THE DRAWINGS

FIG. 1 is a frontal cross section view of one embodiment of the present invention.

FIG. 2 is a frontal cross section view of one embodiment of the present invention.

FIG. 3 is a frontal cross section view of one embodiment of the present invention.

FIG. 4 is a frontal cross section view of an alternative embodiment of the present invention.

FIG. 5 is a graph and corresponding chart used to determine air saturation pressure for the present invention.

### DETAILED DESCRIPTION

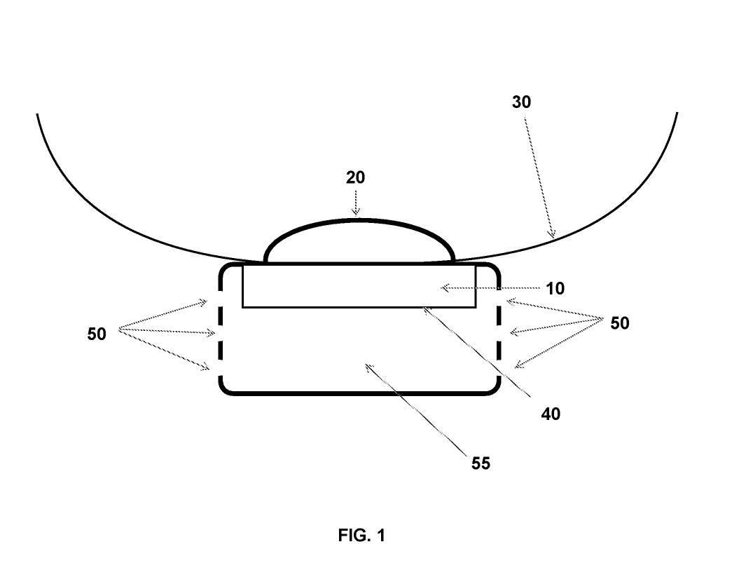

Referring now to the invention in more detail, FIG. 1 shows a frontal cross section of one embodiment of the atmospheric water generator. FIG. 1 demonstrates a fixed volume condensing air chamber 10, wherein the air inside the chamber is heated via a heat conductor 20 that is heated via a solar oven 30. The air temperature rises inside the fixed volume-condensing chamber 10. The inner surface 40 of the fixed volume condensing chamber 10 is cooled by a supply of wind flowing through openings 50 of the wind collection basin 55, causing the air to condense on the cooling surface 40.

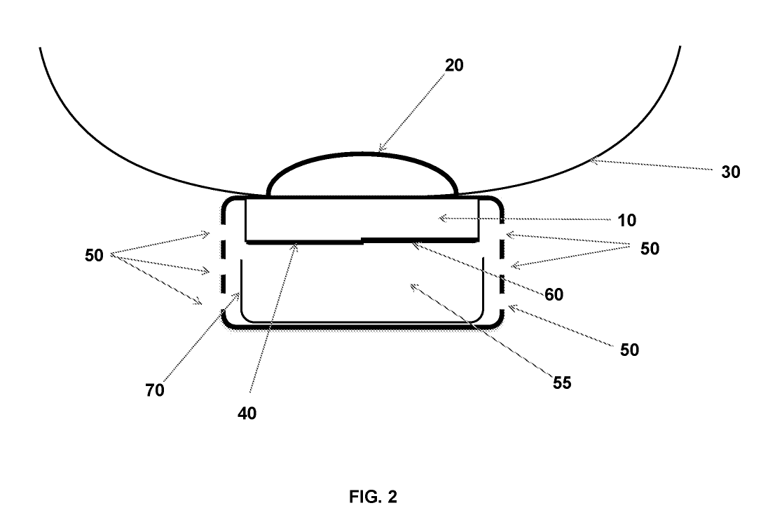

As shown in FIG. 2, when a predetermined amount or weight of water is collected on the cooling surface 40, a trap door 60 swings open, thereby allowing the water to collect in a water collection basin 70 at the bottom of the wind collection basin 55 and the air supply in the fixed volume condensing chamber 10 to be renewed and available for heating again by the heat conductor 20.

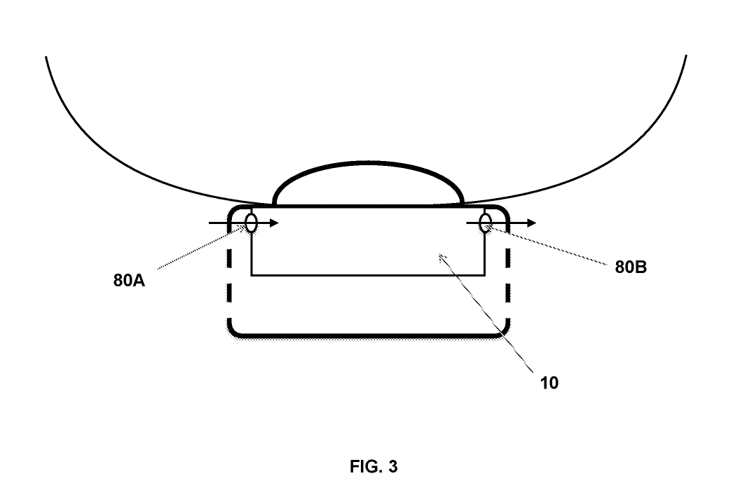

Additionally, as shown in FIG. 3, the fixed volume condensing chamber 10 may have a one way pressure valve 80A and 80B that opens when pressure increases to a predetermined level to allow for the air supply in the fixed volume condensing chamber 10 to be refreshed in order to condense and collect more water. The condensing chamber could be any number of shapes, including a vertical cylinder, a downward facing dome or any other hollow, downward facing shape. The water in the water collection basin 70 may be released through an orifice. In the preferred embodiment, the orifice is a spout structure.

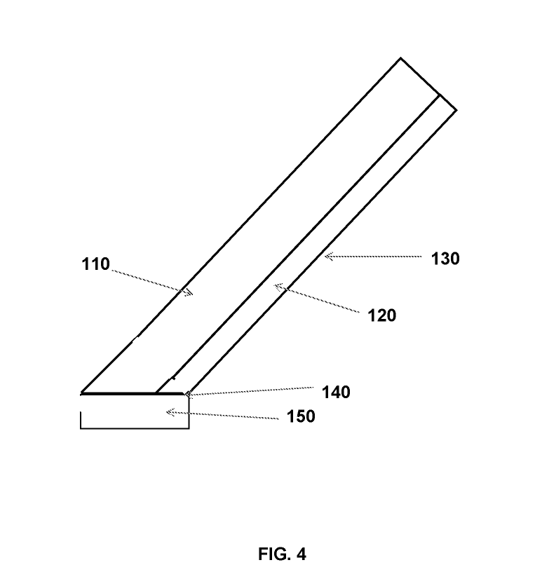

An alternative embodiment of the present invention is shown in FIG. 4 wherein the solar oven 110 heats the fixed volume condensing air chamber 120. The entire apparatus is placed against a roof or tree and uses gravity for water collection as the apparatus is angled from about 30 to about 60 degrees compared to the surface it leans against. The shaded side of the fixed volume condensing air chamber 120 creates a cooling surface 130 where water can condense. When a predetermined amount or weight of water is collected on the cooling surface 130, a trap door 140 swings open, thereby allowing the water to collect in a water collection basin 150 and the air supply in the fixed volume condensing chamber 120 is renewed and available for heating again by the solar oven 110.

The solar ovens 30 and 110 are preferably a reflective disk or panel made out of mirrors or other reflective material, but may generally be represented by any suitable solar heating surface or apparatus that is well known in the prior art. The fixed volume condensing air chambers 10 and 120 can be constructed from a variety of materials, including plastic, metal or wood.

In FIGS. 1-3, a supply of air passes below the bottom surface 40 of the fixed volume condensing air chamber 10 through the wind collection basin 55 and allows the passing air to rapidly cool to ambient temperature, while in FIG. 4 the cooling surface 130 is cooled by lack of sun exposure (i.e. shade created by the angle of the apparatus against the roof, tree or other surface perpendicular to the ground). This differential in temperatures between the wind collection basin 55 and fixed volume condensing air chamber 10 (or the cooling surface 130 and the fixed volume condensing air chamber 120) leads to the condensation of water from air inside the fixed volume condensing air chambers 10 or 120 on the inner surface of the fixed volume condensing chambers 10 or 120. Once the air in fixed volume condensing air chambers 10 or 120 reaches dew point temperature, it condenses into water. The water exits the fixed volume condensing air chambers 10 or 120 through a trap door 60 or 140 at the bottom of the fixed volume air condensing chambers 10 or 120, respectively and enters the water collection basins 70 or 150, respectively. Water can be extracted from an orifice, such as a spigot or a spout, connected to the water collection basin and into external storage container.

The fixed volume condensing air chamber may be lined with a material suitable for absorbing water to increase efficiency, such materials including but not limited to silicon and superabsorbent polymers. The inner surface of the fixed volume condensing air chamber may be lined with a material that increases the electrostatic charge of the cooling surface, thereby increasing condensation. The inner surface of the fixed volume condensing air chamber might also be etched thereby creating a capillary action and increasing the amount of condensed water that is collected.

The overall purpose of this system is to generate differentials in air temperature in order to reach dew point more readily and therefore generate condensation. The air in the fixed volume-condensing chamber will be heated by solar oven, which collects sunlight to generate heat. By heating the air, the dew point will rise; however, the relative humidity will drop. With the volume of the chamber being fixed, the pressure will also rise. This rise in pressure will increase relative humidity. Therefore, even though the relative humidity will decrease with the rise in temperature, it will increase with the rise in pressure. This will allow the dew point to increase to a level over the temperature of the ambient atmosphere.

The following calculations are used in the present invention:

Relative humidity=100×(Partial Pressure)/(Saturation Pressure)

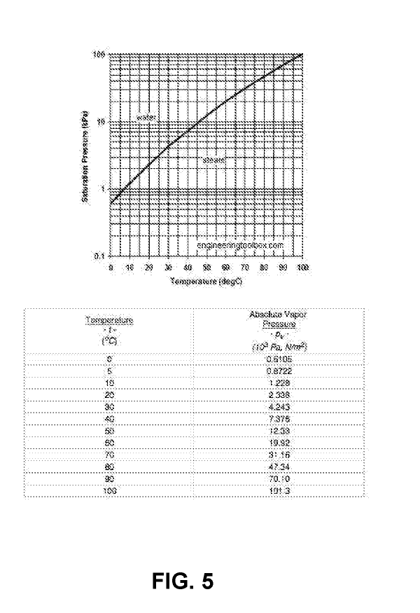

In these calculations, air pressure is assumed to be 1.013 kPa (atmospheric pressure). An air system at 20 C has a saturation pressure of 2.338 kPa. Heating the system to 50C, the saturation pressure will increase to 12.33 kPa (See FIG. 5).

The air in the condensing chamber will be heated by sunlight. This air will be in a fixed volume chamber. By heating the air, the dew point will rise, however, the relative humidity will drop. With the volume of the chamber being fixed, the pressure will also rise. This rise in pressure will increase relative humidity. Therefore, even though the relative humidity will decrease with the rise in temperature, it will increase with the rise in pressure. This will allow the dew point to increase to a level over the temperature of the ambient atmosphere.

According to the equation PV=nRT, increasing heat in the fixed volume chamber will directly increase the pressure. We outline an example below going from 20 C to 50 C, which increases pressure from 1.013 to 2.535 kPA. Using these numbers and the saturation pressures at these temperatures, we reach a relative humidity of 43% in the first state and 20% in the second state.

### State 1: Ambient Air

Temperature=20 C

Assuming air pressure=1.013 kPa

Saturation pressure=2.338 kPa according to the chart in FIG. 5

### State 2: Air Heated Inside Chamber

Temperature=50 C

Pressure=1.013 kPa×2.5=2.535 (according to pV=nRT which states that there is a direct correlation between a rise in temperature and an increase in pressure if volume is fixed).

Saturation pressure=12.33 kPa according to chart in FIG. 5

Using dew point calculations:

### State 1: Ambient Air

Relative humidity=100×(Partial Pressure)/(Saturation Pressure)

43% Relative Humidity=100(1.013 kPa)/(2.338 kPa)

With relative humidity of 43% and temperature of 20 C we reach a dew point of 7 C.

### State 2: Air Heated Inside Chamber

Relative humidity=100×(Partial Pressure)/(Saturation Pressure)

20% Relative Humidity=100(2.535 kPa)/(12.33 kPa)

With relative humidity of 20% and temperature of 50 C we reach a dew point of 22 C. This dew point is above the ambient temperature (20 C), which will allow dew to form. This system will also work at higher temperatures. For example, if we raise the temperature to 60 C, relative humidity will be 15% and dew point will be 25 C, which is above the ambient temperature (20 C).

The advantages of the present invention are that it relies solely on renewable resources to function, and it does not require an additional external power source or form of refrigerant solutions. It can be scaled up to a large size, or be made compact for personal (portable) use. The apparatus requires only one form of energy conversion to generate water, ensuring the most energy efficient process. The present invention can be left to function on its own without constant support or supervision, enabling a certain amount of self-sufficiency. The present invention may be scaled up or down, depending on the need of the user. The present invention may also be set up in a series, thereby creating a “water farm.”

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for generating water from an atmospheric water source comprising:
(a) collecting a fixed volume of ambient air in a chamber;
(b) raising the pressure of the fixed volume of ambient air in the chamber by heating the fixed volume of ambient air with a solar heater thereby increasing the dew point of the fixed volume of ambient air in the chamber;
(c) cooling a surface of the chamber with air outside the chamber;
(d) condensing the water in the fixed volume of ambient air in the chamber on the cooling surface when the dew point is greater than the temperature of the cooling surface that is in contact with outside air;
(d) collecting the resulting dew in a collection basin; and
(f) refreshing the air supply within the chamber.

2. The method of claim 1 further comprising opening a trap door at the bottom of the chamber when the collected dew reaches a predetermined amount.

3. The method of claim 1 further comprising opening a trap door at the bottom of the chamber when the collected dew reaches a predetermined weight.

4. The method of claim 2 wherein the air supply is refreshed when the trap door opens.

5. The method of claim 3 wherein the air supply is refreshed when the trap door opens.

6. The method of claim 1 further comprising activating a one way pressure valve in the chamber to collect more air when the pressure of the fixed volume of ambient air in the chamber reaches a predetermined amount.

7. The method of claim 6 wherein the air supply is refreshed when the one way pressure valve is activated.

8. The method of claim 1 wherein the air outside the chamber is collected wind.

9. The method of claim 1 wherein the air outside the chamber is shaded air.

10. An apparatus for generating water from an atmospheric water source comprising:
(a) a fixed volume air chamber;
(b) a solar oven;
(d) a source of relatively cold air;
(d) a trap door in the bottom of the air chamber; and
(d) a water collection basin
wherein the solar oven collects energy to heat ambient air collected in the fixed volume air chamber;
wherein the bottom surface of the fixed volume air chamber is cooled by the source of relatively cold air thereby condensing water from the fixed volume of heated ambient air in the chamber on the cooling surface when the dew point of the heated air is greater than the temperature of the cooling surface that is in contact with relatively cold air; and
wherein when the water reached a predetermined level or weight, the trap door in the bottom of the air chamber releases to dump the water in the water collection basin.

11. The apparatus of claim 10 further comprising a wind collection basin with a plurality of openings at opposite ends such that the source of relatively cold air is wind flowing through the openings and into the wind collection basin.

12. The apparatus of claim 10 wherein the solar oven and fixed volume air chamber are angled about 30 to about 60 degrees against a surface perpendicular to the ground.

13. The apparatus of claim 12 wherein the source of relatively cold air is air shaded by the angle of the apparatus against the surface perpendicular to the ground.

14. The apparatus of claim 10 wherein the solar oven is a reflective disk or panel comprised of mirrors or other reflective surface.

15. The apparatus of claim 10 wherein the material of the fixed volume air chamber is selected from the group of materials comprising plastic, metal, wood or combinations thereof.

16. The apparatus of claim 10 wherein the fixed volume air chamber is lined with silicon or superabsorbent polymer.

17. The apparatus of claim 10 wherein the inner surface of the fixed volume air chamber is lined with a material that increases the electrostatic charge of the cooling surface.

18. The apparatus of claim 10 wherein the inner surface of the fixed volume air chamber is etched to create a capillary action to increase the amount of condensed water that is collected.

19. The apparatus of claim 10 further comprising an orifice in the water collection basin to release water to a separate collection bin.

20. The apparatus of claim 10 further comprising a one way pressure release valve wherein more ambient air is collected in the fixed volume air chamber and heated air is released when the pressure of the fixed volume of heated air in the chamber reaches a predetermined amount.
